(19) United States
(12) Patent Application Publication
(10) Pub. No.: US 2011/0018378 A1
(43) Pub. Date: Jan. 27, 2011

(54) HYBRID MOTOR FOR TRANSPORTATION

(76) Inventor: Bobby A. Stover, Arab, AL (US)

Correspondence Address: Bobby Stover, P.O. Box 345, Arab, AL, 35016, US

(21) Appl. No.: 12/841,551

(22) Filed: Jul. 22, 2010

Related U.S. Application Data
(60) Provisional application No. 61/227,854, filed on Jul. 23, 2009.

(51) Int. Cl. F02B 63/00; H02K 47/14; H02K 53/00

(52) U.S. Cl. 310/74; 310/113; 415/916

(57) ABSTRACT

A hybrid electric/piston driven motor may use a low voltage, high torque direct current (DC) motor to drive a vehicle, such as a motorcycle. The DC motor may be powered by a battery that may be charged by an alternator/DC generator. The alternator/DC generator may be driven by the movement of the vehicle. The motor may include springs that receive the kinetic energy of the pistons of the motor as the pistons rise in their upstroke. The springs may convert this upstroke kinetic energy to downstroke kinetic energy, minimizing the power needed from the battery.

### CROSS-REFERENCE TO RELATED APPLICATIONS

This application claims the benefit of priority to U.S. provisional patent application No. 61/227,854, filed Jul. 23, 2009, which is herein incorporated by reference in its entirety.

### BACKGROUND OF THE INVENTION

The present invention relates to motors and, more particularly, to a hybrid electric/piston driven motor for use in a transportation vehicle.

Conventional internal combustion piston driven motors consume fuel and, consequently, pollute the environment.

As can be seen, there is a need for motor for driving a vehicle that does not rely on fuel for operation.

### SUMMARY OF THE INVENTION

In one aspect of the present invention, a hybrid motor comprises an engine block having at least two pistons traveling in at least two cylinders; a spring disposed in the cylinder, the spring adapted to be compressed by the piston when the piston is at the top of its stroke in the cylinder; a crankshaft driven by movement of the pistons in the cylinders; a DC electric motor adapted to drive the crankshaft; a least one battery adapted to power the DC electric motor; a generator adapted to be driven by the crankshaft; and a flywheel adapted to be rotated by the crankshaft.

In another aspect of the present invention, a hybrid motor comprises an engine block having at least four pistons traveling in at least four cylinders; a spring disposed in the cylinder, the spring adapted to be compressed by the piston when the piston is at the top of its stroke in the cylinder; a plate disposed above each cylinder, the plate adapted to retain the springs in the cylinders; a crankshaft driven by movement of the pistons in the cylinders; an electric motor adapted to drive the crankshaft; a least one battery adapted to power the DC electric motor; a generator adapted to be driven by the crankshaft; and a flywheel adapted to be rotated by the crankshaft.

These and other features, aspects and advantages of the present invention will become better understood with reference to the following drawings, description and claims.

### BRIEF DESCRIPTION OF THE DRAWINGS

FIG. 1 is an exploded view of the hybrid motor according to an embodiment of the present invention;

FIG. 2 is a flow chart describing the operation of the hybrid motor of FIG. 1;

FIG. 3 is a perspective view of the right-hand side of the hybrid motor of FIG. 1, installed on a motorcycle; and

FIG. 4 is a perspective view of the left-hand side of the hybrid motor of FIG. 1, installed on a motorcycle.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a hybrid electric/piston driven motor that may use a low voltage, high torque direct current (DC) motor. The hybrid motor may be used to drive a vehicle, such as a motorcycle. The DC motor may be powered by a battery that may be charged by an alternator/DC generator. The alternator/DC generator may be driven by the movement of the vehicle. The motor may include springs that receive the kinetic energy of the pistons of the motor as the pistons rise in their upstroke. The springs may convert this upstroke kinetic energy to downstroke kinetic energy, minimizing the power needed from the battery.

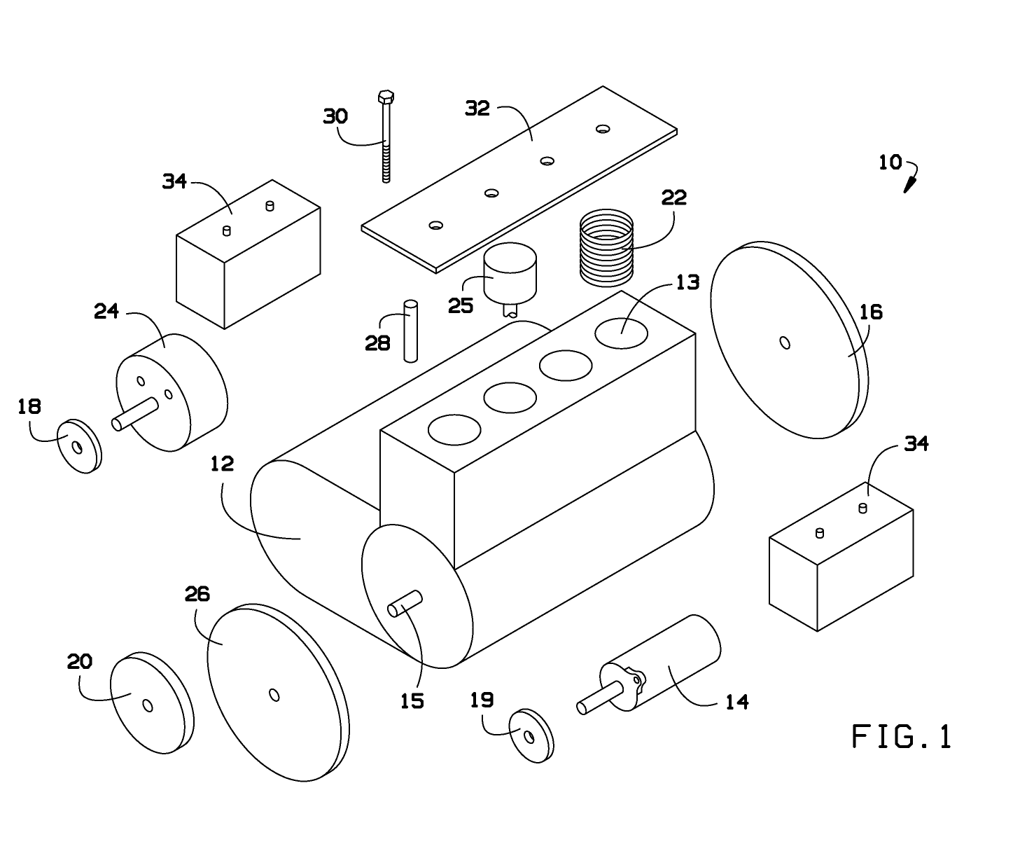

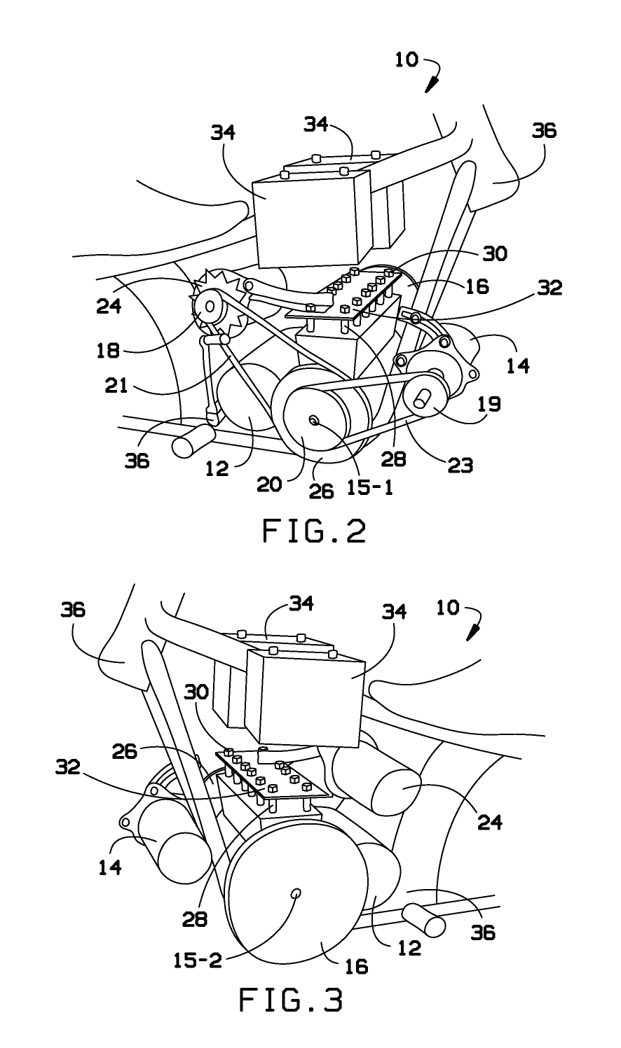

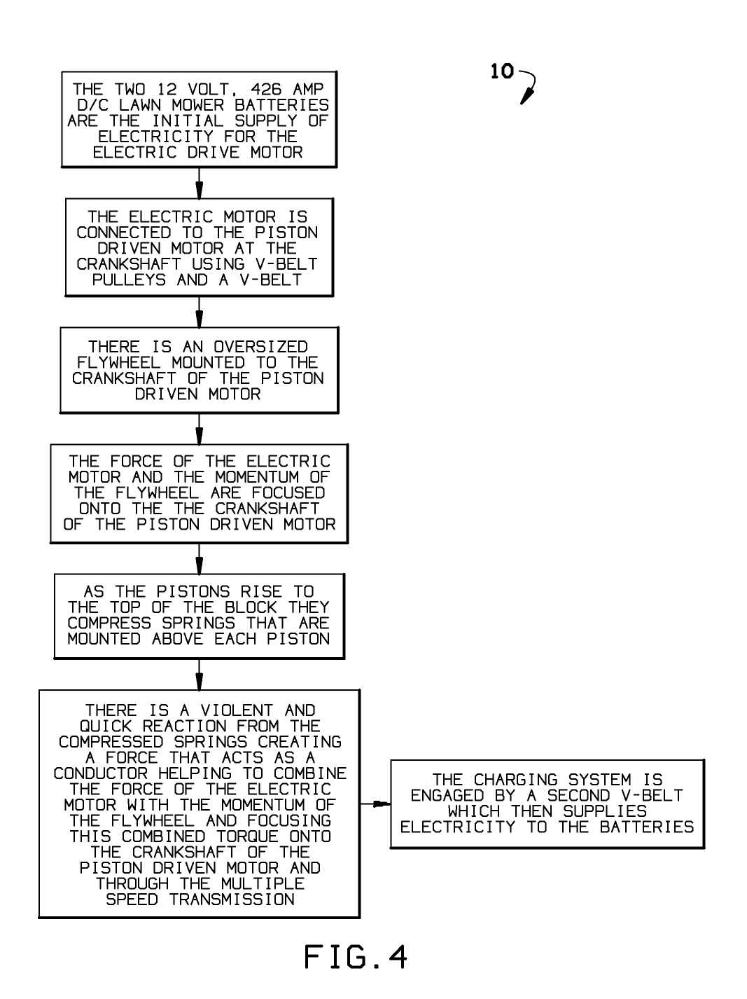

Referring to FIGS. 1 through 4, a hybrid motor 10 may include a motor block 12 containing a plurality of cylinders 13 cut therein. The motor 10 may be, for example, a 500 cubic centimeter (cc) inline four cylinder motor cycle motor with its cylinder head (not shown) removed. A piston 25 may be disposed within each of the cylinders 13, wherein movement of the pistons 25 may drive a crankshaft 15 in a manner similar to a conventional internal combustion engine. A generator drive pulley 26 may be attached to a first end 15-1 crankshaft 15. The generator drive pulley 26 may be a V-belt pulley and may have a diameter between about 8 and 12 inches, typically about 10 inches. An electric motor driven pulley 20 may be disposed on the first end 15-1 crankshaft 15 adjacent to the pulley 26. The electric motor driven pulley 20 may have a diameter from about 2 to about 6 inches, typically about 4 inches. The electric motor driven pulley 20 may be a V-belt pulley.

The generator drive pulley 26 may drive a generator 24 via a belt 21 connected to a generator driven pulley 18. The generator driven pulley 18 may have a diameter from about 1 to about 3 inches, typically about 2 inches. The electric motor driven pulley 20 may be driven by an electric motor 14 via a belt 23 connected to an electric motor drive pulley 19. The electric motor drive pulley 19 may have a diameter from about 1 to about 3 inches, typically about 2 inches. The electric motor 14 may be a 12 volt, 30 amp electric motor that may generate about 8 horse power at 3600 rpm.

The electric motor 14 may be powered by a battery 34, such as a 12 volt DC battery. The battery 34 may be charged by the generator 24. In one embodiment, two batteries 34 may be connected in parallel to provide additional power capacity.

A steel plate 32 may be installed to keep the pistons 25 within the cylinders 13. The steel plate may be bolted to the engine block 12 with bolts 30. Spacers 28 may be disposed between the steel plate 32 and the engine block 12. A spring 22 may be disposed in each cylinder 13, between the piston 25 and the steel plate 32. As described below, the spring 22 may be resiliently deformed longitudinally by the piston 25 pressing the spring 22 into the steel plate 32.

A flywheel 16 may be disposed on a second end 15-2 of the crankshaft 15. The flywheel 16 may have a diameter from about 12 to about 18 inches, typically about 14 inches. The flywheel 16 may be from about 1 to about 2 inches thick, typically about 1.5 inches thick. The flywheel 16 may weigh from about 30 to about 70 pounds, typically about 50 pounds.

In operation, the hybrid motor 10 may be installed in a motorcycle 36. The electric motor 14 may be used initially to turn the crankshaft 15 and create momentum in the flywheel 16. As the pistons 25 move to the top of their stroke in the crankshaft 15, the pistons 25 may compress the springs 22. The kinetic energy of the upward stroke of the pistons 25 may be converted to downward stroke kinetic energy, thereby reducing the power needed by the electric motor 14 to drive the crankshaft 15. Typically, the pistons 25 may compress the springs 22 about 0.75 inch at its upward stroke.

The compressed springs 22 may return the energy to the pistons 25 quickly. While it takes energy to distort the springs 22, the springs 22 may return this energy equally, yet quickly, lessening the time rate for the flywheel 16 to reach maximum angular acceleration. The momentum of the flywheel 16 in rotation may be where the added work energy comes from. The springs 22 may focus the combination of the force of the electric motor 14 with the momentum of the flywheel 16 onto the crankshaft 15. A transmission (not shown) may be connected to the crankshaft 15 to drive the motorcycle 36. The charging system (e.g., the generator 24) may use the potential energy of the mass of the motorcycle 36 to keep the batteries 34 charged. The potential energy of the vehicle is equal to ½ m*v², where m is the mass of the vehicle and v is the velocity of the vehicle. A small percentage of this potential energy is needed to maintain the charge on the system.

The present invention may be adapted to any piston driven motor that has two or more pistons. By using low voltage electric motors, it may be possible to keep the batteries charged while the vehicle is in motion. While described for use in a vehicle, the hybrid motor 10 of the present invention may be used in other systems, such as in power generating motors.

One embodiment of the present invention, as described above, may be used to power the motorcycle 36 for continuous use with little or no need to charge the battery.

It should be understood, of course, that the foregoing relates to exemplary embodiments of the invention and that modifications may be made without departing from the spirit and scope of the invention as set forth in the following claims.

What is claimed is:

1. A hybrid motor comprising:
an engine block having at least two pistons traveling in at least two cylinders;
a spring disposed in the cylinder, the spring adapted to be compressed by the piston when the piston is at the top of its stroke in the cylinder;
a crankshaft driven by movement of the pistons in the cylinders;
a DC electric motor adapted to drive the crankshaft;
a least one battery adapted to power the DC electric motor;
a generator adapted to be driven by the crankshaft; and
a flywheel adapted to be rotated by the crankshaft.

2. The hybrid motor of claim 1, wherein the DC electric motor is a 12-volt electric motor.

3. The hybrid motor of claim 1, wherein engine block has four cylinders with a piston and a spring in each of the four cylinders.

4. The hybrid motor of claim 1, wherein the at least one battery is two batteries connected in parallel.

5. The hybrid motor of claim 1, further comprising a plate disposed on the engine block, the plate covering the cylinders.

6. The hybrid motor of claim 5, further comprising a spacer disposed between the plate and the engine block.

7. The hybrid motor of claim 1, wherein the flywheel weighs from about 30 to about 70 pounds.

8. The hybrid motor of claim 1, wherein the hybrid motor is adapted to provide movement to a vehicle.

9. A hybrid motor comprising:
an engine block having at least four pistons traveling in at least four cylinders;
a spring disposed in the cylinder, the spring adapted to be compressed by the piston when the piston is at the top of its stroke in the cylinder;
a plate disposed above each cylinder, the plate adapted to retain the springs in the cylinders;
a crankshaft driven by movement of the pistons in the cylinders;
an electric motor adapted to drive the crankshaft;
a least one battery adapted to power the DC electric motor;
a generator adapted to be driven by the crankshaft; and
a flywheel adapted to be rotated by the crankshaft.

10. The hybrid motor of claim 9, wherein the DC electric motor is a 12 volt DC electric motor operating at about 30 amperes.
